(19) United States
(12) Patent Application Publication
(10) Pub. No.: US 2016/0292929 A1
(43) Pub. Date: Oct. 6, 2016

(54) Method for electronic modification of parking session data of a vehicle during the parking session

(71) Applicant: Autlo OÜ, Tallinn (EE)

(72) Inventor: Kristjan Konks, Tallinn (EE)

(73) Assignee: Autlo OÜ, Tallinn (EE)

(21) Appl. No.: 15/100,984

(22) PCT Filed: Dec. 2, 2014
(86) PCT No.: PCT/EE2014/000009

§ 371 Date: Jun. 2, 2016

(30) Foreign Application Priority Data
Dec. 2, 2013 (EE) P201300039
Dec. 1, 2014 (EE) P201400040

(51) Int. Cl. G07B 15/02; G07C 9/00; G06Q 20/14

(52) U.S. Cl. CPC G07B 15/02; G06Q 20/145; G07C 9/00134

(57) ABSTRACT

Invention describes a method for altering vehicle's parking session data during an ongoing parking session when the vehicle is assigned incorrect parking area when parking in a restricted parking area, the method is performed by multiple user terminal communication module user interfaces. Using the method fine or other sanctions to the vehicle user are avoided for the whole parking session. The user interface can be either the user of the vehicle or parking inspector.

### TECHNICAL FIELD

This invention belongs in the field of technical methods for arranging parking of vehicles, more specifically, methods involving fixing the parking of a vehicle within a parking zone with restrictions and/or calculating the fees due for parking, or parking, using a parking disc or permit, whereas the applicability of parking rights is checked by means of either electronic equipment or automatic systems.

### PRIOR ART

In cities and other areas, characterised with high concentration of vehicles, there are regions where the demand for parking exceeds the supply. Parking in these regions is regulated with the following tools:
imposing a fee for parking;
restricted parking rights (e.g. based on permits);
restricted parking time (e.g. based on parking discs);
combinations of the afore-mentioned.

Earlier, parking was paid for by using parking meters and purchased parking cards. Long-term parking cards and parking permits were issued on paper. All the documents, providing proof of parking rights, used to be on paper, which was usually placed on the dashboard of the vehicle, under the windshield.

Today, electronic devices are mostly used to pay for the parking of vehicles. SMS text messages, data communication, mobile phone applications or other applications are used to pay for parking. As a rule, parking is activated by an individual i.e. user of the vehicle, by giving a relevant order (see Estonian utility model no. EE 00315 U1, published 15.07.2002).

Today, more expensive vehicles are fitted with a GPS positioning system. Some vehicles (such as Nissan Leaf) can also be fitted, on request, with telematic driving and control systems. These systems are becoming less expensive and today are already included in the standard equipment of several new vehicles that are introduced to the market (for example, Renault R-Link for Renault Clio).

The e-Call system (http://ec.europa.eu/digital-agenda/ecall-time-saved-lives-saved), which positions the coordinates of a vehicle and makes a call to the control centre in case of a road accident, will become mandatory in the European Union from October 2015. This means that even today there are vehicles with integrated positioning systems (e.g. GPS) and data communication systems (e.g. GSM) in the market. The first manufacturer-based stores of electronic applications are already emerging (e.g. Renault R-Link store, similar to models known from smart-devices; there is an Apple Store for devices by Apple and Play Market for Google Android equipment). The above-said provides an opportunity for presenting an automated parking solution, which is based on the stopping of the vehicle, involving:
identification of the location of the vehicle, using a global positioning system;
co-ordinates of the location are sent to the main server of organiser(s) of parking;
in the main server of organiser(s) of parking, the location of the vehicle is compared with the paid parking zones and parking zones with restrictions, and with parking rights available to the vehicle concerned;
followed, automatically, by one of the operations listed below:
   no action is taken, if the vehicle has stopped in a parking zone with no restrictions;
   paid parking session will commence, if the vehicle has stopped in paid parking zone;
   time-based parking session will commence, if the vehicle has stopped in a zone with time restrictions;
   the fact of parking is recorded or no action is taken.

Combinations of the above options can also be applied.

The whole process of parking can be tracked separately for each vehicle, the service can be activated or changes implemented through electronic control devices (smart-phone, tablet, computer or other known equipment).

A method for organisation of parking is also known from patent application EE 201100026 A (published Dec. 17, 2012), in which the event of vehicle parking commencement is activated by a microprocessor fitted into the vehicle, and the parking event is linked to a parking zone in the system of the parking service provider.

Known is also a solution described in patent application WO 01/88856 A1 (published Nov. 22 ,2001) about a method which reduces the probability of the user activating the parking of a vehicle in an incorrect parking zone.

The problem entailed in the solutions above is that the accuracy of the positioning of the vehicle or exact location of the parking zone (e.g. different parking zones on opposite sides of the street, exact border of private parking areas) may contain an error, or disturbances caused by the environment or reliability of the system, may occur. The problem is that in such situations it is possible that the vehicle can be assigned to a parking zone where it actually is not located, i.e. incorrect parking information is activated, which may result in a fine or other sanctions for the user of the vehicle for parking his/her vehicle in a parking zone with incorrect restrictions, while the user has no direct possibility to modify the parking zone of the parked vehicle during the parking session.

In solutions known from prior art the parking zone data of a vehicle can only be modified by the database administrator by manually changing the parking session entry in the database of parking data (see e.g. EE201100026 A), which is normally carried out after termination of the parking and recording the complete parking session. Thereby it is possible that the parking person i.e. user of the vehicle in whose case the procedure of the parking session has been started and/or terminated correctly, but the result is the generation of an incorrect parking entry in the parking system. Another known solution is when the parking zone is selected incorrectly, in which case the given parking session is terminated and a new parking session with the data of correct parking zone is started immediately.

The invention presents a solution, which enables changing the parking data of a vehicle parked in a parking zone with restrictions by means of a user device, while also a third party (e.g. a parking inspector) is given the capacity to do it. This means that the user of the vehicle and the parking inspector can both be the users. Using multiple users to modify a parking entry allows a bona fide parking person to pay according to the rate of the respective parking zone with restrictions, while this arrangement is especially beneficial for tourists who wish to park their vehicles according to the requirements of the parking zone, but due to their lack of information, poor language skills or other circumstances identify the parking zone incorrectly.

### SUMMARY OF THE INVENTION

This invention presents an electronic vehicle parking method by which the parking data assigned incorrectly for the parking session of a vehicle parked in a parking zone with restrictions can be changed electronically at the comparison node of the service provider during the parking directly through the communication module (not indicated on Figures) of different terminals (either through the parking inspector's interface or vehicle user's interface), avoiding thereby the generation of an incorrect parking entry and imposing of a fine or other sanctions to the user of the vehicle, and this for the whole parking session.

The profiles and rights of the user interfaces are described respectively in the comparison node, such as creating authorisations as a result of data exchange outside the parking session, while the interface of the parking inspector allows both reading as well as changing an existing active parking entry of a vehicle (such as changing the identifier or other parameter of the parking zone of a vehicle parked during a parking session), and the interface of the user of the vehicle allows generation of a parking entry and activating the parking entry for changing, cancelling or terminating one or more parameters therein. An active parking entry means one parking entry activated for a vehicle in the comparison node, an entry which is activated, but not terminated yet.

A parking entry contains selected parameters that are used to allow or restrict the application of the method described in this invention, as a result of which the user of a vehicle is enabled to change an activated and active parking entry.

A parking entry includes among other the identifier of the parking zone, registration number of the parked vehicle, time of activation of the parking entry, identifier of the person activating the parking entry, various parameters of the person changing the parking entry (such as the time of change, identifier of the person changing and similar), as well as the parameters of the parking entry processing rights (such as extension of the processing right to third user terminals, list or a reference to the list of user terminals with the processing right, etc.), time of termination of the parking entry, coordinates of the vehicle and similar.

According to the invention, the parameters of the active parking entry are modified in the comparison node to correspond to the data of the actual parking zone of the vehicle, without interrupting the parking session. Should it be necessary to terminate the parking entry, an alternative execution will involve modification of the parking data of the current parking session in the comparison node to correspond to the data of the actual parking zone of the vehicle, so that the active parking entry is terminated and a new parking session with the parameters of the modified parking zone is started immediately.

It is essential that irrespective of the method of changing the data of the current parking session (whether the parking session was interrupted or not), the initial parking in the incorrect parking zone with restrictions will entail no sanctions for the user of the vehicle in case of an existing parking session, as the user can change the parking data of the vehicle during the parking session directly by means of a communication device, while the changes take effect retroactively for the user of the vehicle from the beginning of the parking session.

It is possible to use the method, when the user of the vehicle which will be parked in a parking zone with restrictions sends through the communication module of the user terminal or the vehicle itself sends (proceeding from the hardware/software configuration of the vehicle) to the comparison node electronically a parking commencement message, identifier of the parking zone or coordinates of the vehicle, to start the parking session. The comparison node has been supplied with the parameters of all entered parking zones (zone name, accurate parking maps or polygons bordering with geographic points, parking rates, duration of free parking, vehicles with parking permission, permitted duration of parking or other data) and the parking is commenced or terminated automatically.

According to the method:
Vehicle 1 is parked in a parking zone with restrictions, whereas the starting time of parking, parking zone or coordinates of the vehicle are recorded electronically either by vehicle 1 itself or by the user of the vehicle through interface 6 by means of the communication module of user terminal 4 in order to initiate the parking session.
For the generation of the parking entry, the information about rights for modification of parking entries (such as authorisation from other user terminals to change an active parking entry and the list of these terminals or a reference to the above-described list) is sent selectively to comparison node 3.
The parking inspector's interface 5 or vehicle user's interface 6 establish during the parking session of vehicle 1 that vehicle 1 has been parked in an incorrect parking zone (i.e. a parameter of active parking entry, which is incorrect).
When incorrect parking zone has been detected during the parking session of vehicle 1, the parameters to be modified in the active parking entry of vehicle 1 to correspond to the actual parking zone with restrictions to vehicle 1 are sent electronically to comparison node 3 during the parking session directly by means of the communication module of user terminal 4 (either parking inspector's interface 5 or vehicle user's interface 6). Modifications are effected in comparison node 3 via a communication module (smart-phone, tablet, computer or another known equipment), which is connected to a communication network 2 (e.g. the Internet), changing the parking zone data (parking zone name/code/area or other data) in the parking entry of the current parking session of vehicle 1.
The user of the vehicle has the right to continue parking in the parking area with restrictions, which entails obligations for parking in a parking zone with restrictions as to the intended parking zone assigned to vehicle 1 directly by communication module 4 of the user terminal, and this with retroactive effect from the beginning of the parking session (i.e. time of commencement of the parking session in the initially incorrect parking zone).
The data of a parking session together with possible modification(s) of parking data are recorded in the database of comparison node 3.
Comparison node 3 sends to the user terminal 4 selective data about the changes in the active parking entry, including the parameters of the changed parking entry, such as the time of change, identifier of the persons initiating the modification and other data.
After the end of parking, the data related to the parking of vehicle 1 are sent from comparison node 3 to information systems via communication network 2 to the database of main server 7, where parking events P₁, P₂ to Pₙ are recorded.
The basic information (vehicle identification, zone, time of commencement and end of parking) for the payment of a parking session of vehicle 1 parked is sent, if applicable (i.e. in case of paid parking zone and/or parking zone with time restrictions and/or parking zone with permits), through communication network 2 based on parking session data recorded in comparison node 3 (i.e. based on changed data with retroactive effect from the beginning of the parking session) to a parking and/or payment operator 8, who has a settlement agreement with the client (different operators are marked as O₁, O₂, Oₙ). Settlement is executed selectively as follows:
   in a preferred embodiment as full amount in a single payment retroactively according to the rate of the modified parking zone;
   alternatively as several payments (e.g. for the initial parking zone according to the parking rate applicable to the zone concerned, for the new parking zone according to the parking rate applicable to the zone concerned, while adjustment or setting off the fee is possible, if the rate of the new parking zone differs from the rate of the previous one).
In addition to the final parking information, the main server 7 sends to the information systems 8 of parking and/or payment operators also the information of the earlier parking sessions of vehicle 1 together with related modifications (i.e. logs about changes in parking sessions, whereby the misuse of the system by user(s) is minimized and excluded by means of software).
The communication module of user terminal 4 (telephone, tablet, computer or other known equipment) is equipped with user interface software for making queries and receiving replies about the history of the parking sessions of vehicle 1.

The above-described stages of the method are executed by means of hardware.

### LIST OF FIGURES

FIG. 1 shows the conceptual flowchart of activities under the method of the invention.

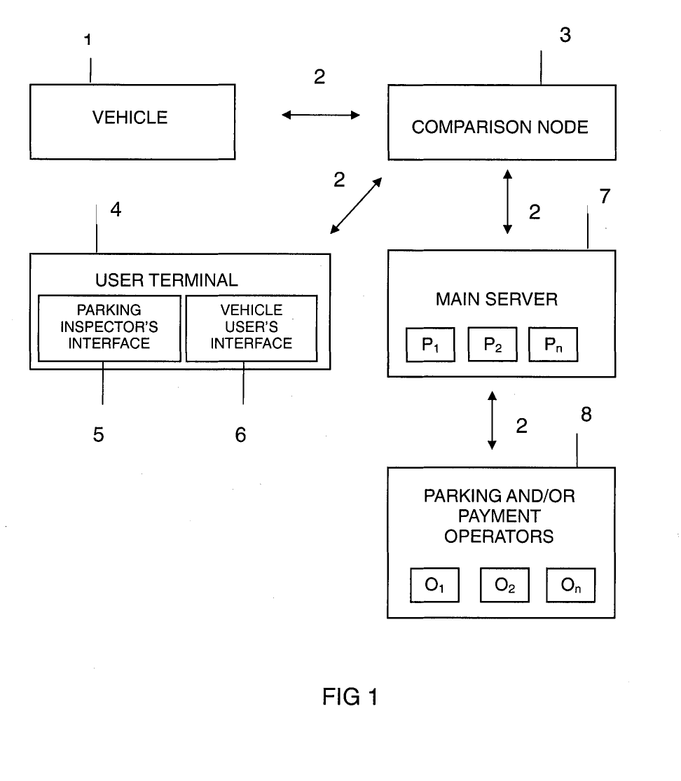

FIG. 2 shows the flowchart of user's activities, describing the sequence of activities carried out by the user accordingly to the method of the invention, incl. in the box marked in a bold line in FIG. 2 of the comparing node:

1. Starting the parking. Based on switching off the engine of vehicle 1, locking its doors or another activity specified by the user of the vehicle.

2. Sending the parking initiation order, GPS coordinates and time stamp to comparison node 3. The data is sent by vehicle 1 itself or an electronic system connected to vehicle 1 or by the user of the vehicle over communication network 2.

3. Parking zone is selected in comparison node 3 by comparing the received GPS coordinates with the parking areas (polygons) available to comparison node 3. If a parking area with an applicable fee, time restrictions and/or permits is located at the given coordinates, parking in the given parking zone is started. If the parking zone has no applicable fee or restrictions, parking in a free and unrestricted parking zone is started.

4. Comparison node 3 activates user notification, which is performed through the communication module to the mobile phone or e-mail of the user of the vehicle.

5. Modification of the parking zone. The data of the current parking session can be changed in comparison node 3 during the parking session both by the user of the vehicle and by the parking inspector. If the parking zone is modified by the parking inspector, it will be possible to send further notices to the user of the vehicle. In the preferred embodiment the data of the active parking zone (name, restrictions, cost, etc.) are overwritten in the event of parking modification.

6. Ending the parking. The basis for ending the parking is either ignition of the engine of vehicle 1, opening its doors or another activity determined by the user of the vehicle, incl. stopping and cancelling.

7. Sending the GPS coordinates and time stamp of the parking ending activity to comparison node 3. The data are sent by vehicle 1 itself or by the user of the vehicle over communication network 2.

8. Parking is ended either in the parking zone determined initially by comparison node 3 or in the parking zone modified later by the user of the vehicle or the inspector. The given parking data are saved in comparison node 3, are sent as log entries to main server 7 and if applicable, to parking and/or payment operators 8.

9. The user is notified about the occurred parking, incl. zone name and cost. The user has an opportunity to configure in comparison node 3, which notices should be sent (such as notices only about paid parking).

10. The entry of occurred parking is saved in the database of main server 7 and if necessary, in the database of the information system of parking and/or payment operator 8. It is possible to configure, which entries should be sent (such as all entries, only paid or with time restrictions or only paid).

### PREFERRED EMBODIMENTS OF THE INVENTION

According to the method of the invention, upon the initiation of a parking session of vehicle 1 in a parking zone with restrictions (e.g. parking zone for pay and/or with permits and/or time restrictions) either with a message sent by vehicle 1 electronically (either upon stopping the car or engine, locking, etc., depending on hardware and software settings of the vehicle) or by inspector's interface 5 or vehicle user's interface 6 for the electronic activity of initiating the parking and sending the identification or coordinates of the parking zone, the coordinates of vehicle 1 are recorded and sent through communication network 2 to comparison node 3, where the parking zone and related parameters, such as valid parking right(s) at the location of vehicle 1 are established as a result of data processing, followed by generating an active parking entry about the beginning of the parking of vehicle 1.

The user of the vehicle always has an alternative to switch the automatic parking system of vehicle 1 on or off separately, and to initiate the activities for starting or ending the parking of vehicle 1 (e.g. when vehicle 1 has recorded by itself the beginning of parking, but this is modified, ended or cancelled through the vehicle user's interface 6).

The existence of the parking session of vehicle 1 is verified through the parking inspector's interface 5 and the lawfulness is verified by means of the communication module of electronic user terminal 4 (not indicated separately in the Figure) and according to one preferred embodiment, the parking zone parameter in the active parking entry of the parking session of vehicle 1, which is incorrectly parked, is modified electronically directly by means of the communication module of electronic user terminal 4 to correspond to the actual location of vehicle 1. The modification is executed by sending the information to comparison node 3 over a communication module (smart-phone, tablet, computer or other known equipment) of user terminal 4, which is connected to communication network 2. When the information has been received in comparison node 3, the parameters of the modification are compared both with the parameters of known parking zones as well as the parameters in the active parking entry concerning the authorisation of modification, and depending on the results of the comparison, the active parking entry is either modified or not.

When parking of vehicle 1 is ended, either automatically by the vehicle (upon opening the doors of the vehicle, ignition of the engine, driving off or other activity, depending on the hardware and software configuration of the vehicle) or by electronic termination of parking from vehicle user's interface 6 as information about the end of the parking session of vehicle 1, sent by means of the communication module of user terminal 4 through communication network 2 to comparison node 3, whereafter the occurred parking is recorded by the comparison node 3 and also sent to the main server 7 in the form of log entries (parking events P₁, P₂ to Pₙ). In this preferred embodiment, the parking inspector's interface 5 through the communication module of user terminal 4 enables only reading and modification, but no removal or deletion of an existing parking entry.

According to another embodiment, the modification is effected by the vehicle user's interface 6, when it has established that the parking session of vehicle 1 has not been initiated or the session is being executed in an incorrect parking zone with restrictions, while the parking zone entry of the vehicle is modified in comparison node 3 electronically during the parking session by means of the communication module of user terminal 4. For this purpose vehicle user's interface 6 sends electronically the new data of the parking zone with restrictions for vehicle 1 during the parking session through communication network 2 to comparison node 3 in order to modify the active parking entry. The new parameters of the parking zone are recorded by the comparison node 3 also in the logs (parking events P₁, P₂ to Pₙ) of the database of main server 7 after the end of parking.

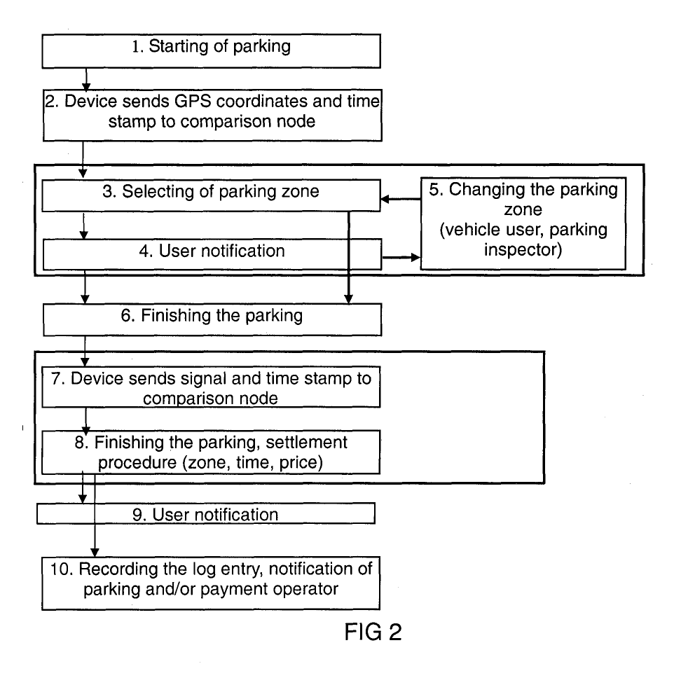

Based on parking information sent from the database of main server 7, settlement for the parking of vehicle 1 is made with the help of a parking and/or payment operator 8 (various operators are marked as 0₁, 0₂, 0ₙ in FIG. 2), as applicable.

User terminal 4 has software supported interface for comparing the history of parking session entries of vehicle 1 in comparison node 3 through a communication module (telephone, tablet, computer or another known equipment) connected to communication network 2 (e.g. the Internet).

In addition to specific parking information, the information systems of parking and/or payment operators 8 also receive selectively data about the earlier parking sessions and related modifications of vehicle 1 (i.e. logs about modification of parking sessions) in order to prevent misuse of the system by user(s).

In case of the above embodiments, with the electronic modification of the parking zone effected directly by means of the communication module of user terminal 4, the right of the user of the vehicle to continue parking vehicle 1 in a parking zone with restrictions remains, and the obligations arising from parking in a parking zone with restrictions are generated according to the new determined parking zone and this retroactively from the beginning of the parking session of vehicle 1. No fines or sanctions will be imposed to the user of the vehicle for the parking session, which had initially occurred with incorrect parking data in a parking zone with restrictions.

It is vital to understand that this description of the invention and the preferred embodiments are only intended to illustrate what has been set forth herein. The variation and modifications of the invention (such as partial or complete merger of comparison node 3, database of main server 7 and/or systems of parking and/or payment operators, also changing the active parking entry of the car from free zone to paid zone or vice versa) are obvious for persons skilled in the art, without these being different from the description of the invention provided here.

1. A method for electronic modification of a parking session data of a vehicle during a parking session, wherein the user can initiate and terminate a parking entry in a comparison node of a parking service provider by means of a user terminal with a communication module, and a parking inspector can view and check accuracy of data contained in one or more active parking entries by means of an inspector's interface of a user terminal with a communication module, and wherein the method is applied in an external hardware based system and an administrator of the parking system is given capacity to modify parking entries after deactivation of the parking entry, the information in parking entries is utilised in payment systems, and wherein interfaces of user terminal are used to modify one or more active parking entries via the communication module, and the comparison node is adapted among other to send and receive messages with the user terminal over the communication network and via the communication module, while the user terminal and the comparison node exchange messages also outside the parking session; data processing concerning the parking session of one and the same vehicle is performed by a number of interfaces of the user terminal in the comparison node; when the need to modify an active parking entry of a vehicle has been established, the parameters of the actual parking zone of the vehicle are sent directly by the interface electronically after processing the electronic message of parking initiation of the vehicle via the communication module to the comparison node during the parking session of the vehicle, to modify the active parking entry of the vehicle, while the modification of data about parking ensures that the parameters describing the parking can be used in the comparison node retroactively from the beginning of the parking session of the vehicle; the parameters modifying the active parking entry are processed in the comparison node and depending on the comparison results, the scope of modification of the parameters of the active parking entry is determined and the parking entry of the vehicle is modified; the parameters to be modified in the active parking entry or a summary of these are generated and sent by the comparison node to the user terminal defined in the parking entry of the active vehicle.

2. The method accordingly to claim 1, wherein the method is adapted to send the modified data of the parking session of the vehicle from the comparison node over a communication network to the database logs of the main server (parking events P₁, P₂ to Pₙ) and to the database of the information system of parking or payment operators.

3. The method accordingly to claim 1, wherein the user terminal is configured with the functionality of a parking inspector's interface, which again is used to modify one or more parameters of an active parking entry generated for the vehicle previously in the comparison node.

4. The method accordingly to claim 3, wherein the functionality of parking inspector's interface is applied on a selective basis to modify a parameter of an active parking entry generated for the vehicle previously in the comparison node, with simultaneous generation of a new active parking entry, while the previous active parking entry is terminated after the modification of one or more parameters in the parking entry.

5. The method accordingly to claim 1, wherein the parking entry of vehicle is activated, one or more parameters in an active parking entry are modified and terminated in the comparison node through the interface of the user of the vehicle.

6. The method accordingly to claim 1, wherein optionally a settlement functionality is applied by which a parking or payment operator sends information for the modification of the existing parking entry of the vehicle on the basis of modified data of the parking session of the vehicle as recorded in the comparison node, with retroactive effect from the beginning of the parking session of the vehicle.

7. The method accordingly to claim 1, wherein the user terminal is adapted to use a software interface to compare over an electronic communication module connected to a communication network the log of parking sessions of the vehicle available in the comparison node.

8. The method accordingly to claim 1, wherein the data of earlier parking sessions and related modifications of the vehicle are issued from the database of the main server to one or more parking operators.

9. The method accordingly to claim 1, wherein software is adapted to prevent of fraudulent use of the method.

10. The method according to claim 1, wherein messages are sent between the communication module of the user terminal and the comparison node outside the parking session about the authorisations for modification of the parking entry, according to which all modifications in parking entries are authorised in a single exchange of information via the communication module of the user terminal or according to which an authorisation parameter, which is used for executing a new authorisation for each modification of a parking entry, is generated in the comparison node via the communication module of the user terminal.
